(19) United States
(12) Patent Application Publication
(10) Pub. No.: US 2006/0230052 A1
(43) Pub. Date: Oct. 12, 2006

(54) Compact and hitlessly-resizable multi-channel queue

(75) Inventor: Ygal Arbel, Morgan Hill, CA (US)

Correspondence Address: Wilson & Ham, PMB: 348, 2530 Berryessa Road, San Jose, CA, 95132, US

(73) Assignee: Parama Networks, Inc., Santa Clara, CA (US)

(21) Appl. No.: 11/103,978

(22) Filed: Apr. 12, 2005

(51) Int. Cl. G06F 7/00

(52) U.S. Cl. 707/101

(57) ABSTRACT

A queue is disclosed (i) that provides for single-channel and multi-channel operation and that can change between single-channel and multi-channel operation during operation hitlessly, (ii) in which the number of channels and each channel's size can be changed during operation hitlessly, and (iii) is compact. To accomplish this, the illustrative embodiment comprises a group of doubly-linked lists, one for each channel's storage. One set of links indicates the node where the next datum is to be written and the other set of links indicates the node where the next datum is to be read. By bifurcating each channel's queue into a set of write links and read links, the illustrative embodiment can resize a channel during operation hitlessly.

### FIELD OF THE INVENTION

The present invention relates to data processing in general, and, more particularly, to data structures and queues.

### BACKGROUND OF THE INVENTION

There are many applications in data processing systems and telecommunications for multichannel queues whose channels can be resized and whose overall size is compact, and the need exists for a multichannel queue that can be resized hitlessly (i.e., without losing any data, repeating data, or introducing garbage data).

### SUMMARY OF INVENTION

The present invention provides for a queue:
i. that provides for single-channel and multi-channel operation and that can change between single-channel and multi-channel operation during operation hitlessly, and
ii. in which the number of channels and each channel's size can be changed during operation hitlessly, and
iii. is compact.

To accomplish this, the illustrative embodiment comprises a group of doubly-linked lists, one for each channel's storage. One set of links indicates the node where the next datum is to be written and the other set of links indicates the node where the next datum is to be read. By bifurcating each channel's queue into a set of write links and read links, the illustrative embodiment can resize a channel during operation hitlessly.

Each node's storage in each data link comprises a plurality of words, which enables the linked lists to have fewer links in them than they would if each node's storage merely comprised one word. This adds to the compact nature of the illustrative embodiment.

There are two devices employed to enable the queue to be compact. First, each node's storage in each data link comprises a plurality of words, which enables the linked lists to have fewer links in them than they would if each node's storage merely comprised one word. And second, the illustrative embodiment shares its storage capacity among all its channels so that as one channel's storage requirements decrease, a portion of its storage capacity can be allocated to one or more other channels.

The illustrative embodiment comprises: a first memory comprising 2^{N} individually-addressable words; a second memory comprising 2^{M} individually-addressable M-bit words, wherein each of the M-bit words is (1) a pointer into the second memory and (2) at least a portion of a pointer into the first memory; and a third memory comprising 2^{M} individually-addressable M-bit words, wherein each of the M-bit words is (1) a pointer into the third memory and (2) at least a portion of a pointer into the first memory; wherein M and N are positive integers and N≧M.

### BRIEF DESCRIPTION OF THE DRAWINGS

FIG. 1 depicts a block diagram of the illustrative embodiment of the present invention, which is a hitlessly-resizable multi-channel first-in/first-out queue.

FIG. 2 depicts a block diagram of the salient components of the illustrative embodiment of the present invention.

FIG. 3 depicts a flowchart of the salient tasks associated with the operation of the illustrative embodiment.

FIG. 4 depicts a flowchart of the salient tasks associated with the performance of task 301.

FIG. 5 depicts a flowchart of the salient tasks associated with the performance of task 302.

FIG. 6 depicts a flowchart of the salient tasks associated with the performance of task 303.

FIG. 7 depicts a flowchart of the salient tasks associated with the performance of task 501, in which processor 201 receives a word from incoming data stream 102, determines that it is within channel c, and stores it in queue c.

FIG. 8 depicts a flowchart of the salient tasks associated with the performance of task 502, in which processor 201 removes a word from queue c and transmits it in channel c of outgoing data stream 203.

FIG. 9 depicts a flowchart of the salient tasks associated with the performance of task 305.

FIG. 10 depicts a flowchart of the salient tasks associated with the performance of task 306.

FIG. 11 depicts queue c in which each pointer in write link memory 204 (1) points to the next link in the list, and (2) the next block in data memory 201 for writing words associated with that channel.

FIG. 12 depicts queue c in which location c in write pointer memory 203 and location c in read pointer memory 203 have been primed with an N-bit word that is a composite of the address of a link in the circular link list constructed in task 402.

FIG. 13 depicts queue c after processor 201 has written 0×134 into read link 0×042.

FIG. 14 depicts queue c at the beginning of task 305.

FIG. 15 depicts queue c a the completion of task 9023.

FIG. 16 depicts queue c after task 903 has been performed.

FIG. 17 depicts queue c after task 904 has been performed.

FIG. 18 depicts queue c after processor 201 copies the contents of location 0×134 in write link memory 204 (i.e., 0×354) into location 0×134 in read link memory 206.

FIG. 19 depicts queue c after processor 201 copies the contents of location 0×354 in write link memory 204 (i.e., 0×007) into location 0×354 in read link memory 206.

FIG. 20 depicts queue c after the completion of task 1003.

FIG. 21 depicts queue c after the completion of task 504 to reflect the removal of the child_data_block.

FIG. 22 depicts queue c after the completion of task 1004.

### DETAILED DESCRIPTION

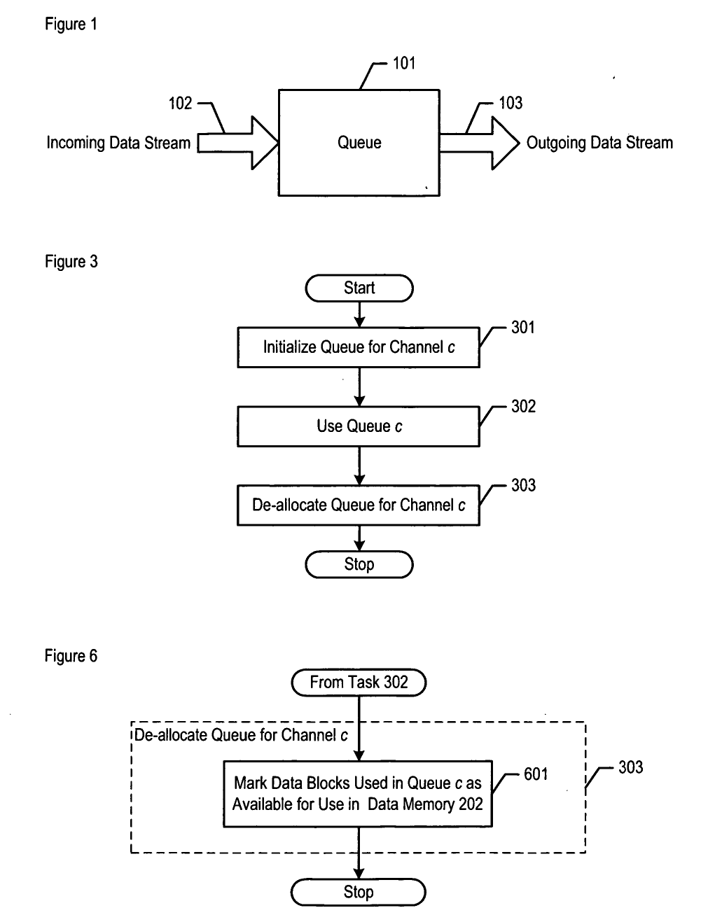

FIG. 1 depicts a block diagram of the illustrative embodiment of the present invention, which is a hitlessly-resizable multi-channel first-in/first-out queue. Queue 101 receives a stream of up to S W-bit words per second on incoming data stream 102, wherein S and W are positive integers, and holds them, on average, for up to D seconds. In accordance with the illustrative embodiment, S=2²⁰=1,048,576, W=8, and D= 1/16=0.06250 seconds. It will be clear to those skilled in the art, after reading this disclosure, how to make and use alternative embodiments of the present invention for any values of S, W, and D.

At any one instant, incoming data stream 102 comprises j time-division multiplexed channels, wherein j is a positive integer and 1≦j≦S/D. Each word in incoming data stream 102 is uniquely associated with exactly one of the j channels. The number of channels in incoming data stream 102 can change over time, and the illustrative embodiment is capable of handling these changes hitlessly. In accordance with the illustrative embodiment, j=128. It will be clear to those skilled in the art, after reading this disclosure, how to make and use alternative embodiments of the present invention for any value of j.

In accordance with the illustrative embodiment, the number of words arriving at queue 101 per second within each channel can be different for each channel, subject to the following constraint:

$$S \geq {\sum }_{c = 1}^{j} {S}_{c} \qquad ( Eq . 1 )$$

wherein s_{c} is the number of words per second in channel c, wherein c ε {1, . . . , j}. Furthermore, the number of words arriving at queue 101 per second within each channel can also change over time. The illustrative embodiment is capable of handling the disparity in the number of words per channel and changes in the number of words per second per channel hitlessly.

The length of time that the words in channel c can be held in queue 101 is independent of s_{c} but is subject to the following constraint:

$$D \geq {\sum }_{c = 1}^{j} {d}_{c} \qquad ( Eq . 2 )$$

wherein d_{c} is the delay for channel c in queue 101.

In accordance with the illustrative embodiment, outgoing data stream 103 comprises j channels, and the words within each channel must be transmitted in outgoing data stream 103 in the same order that they are received from incoming data stream 102. In other words, the integrity of the sequence of words within each channel must be preserved, but the integrity of the sequence of words across channels need not be preserved. It will be clear to those skilled in the art, however, after reading this specification, how to make and use alternative embodiments of the present invention in which the integrity of the sequence of words within each channel and across channels is preserved.

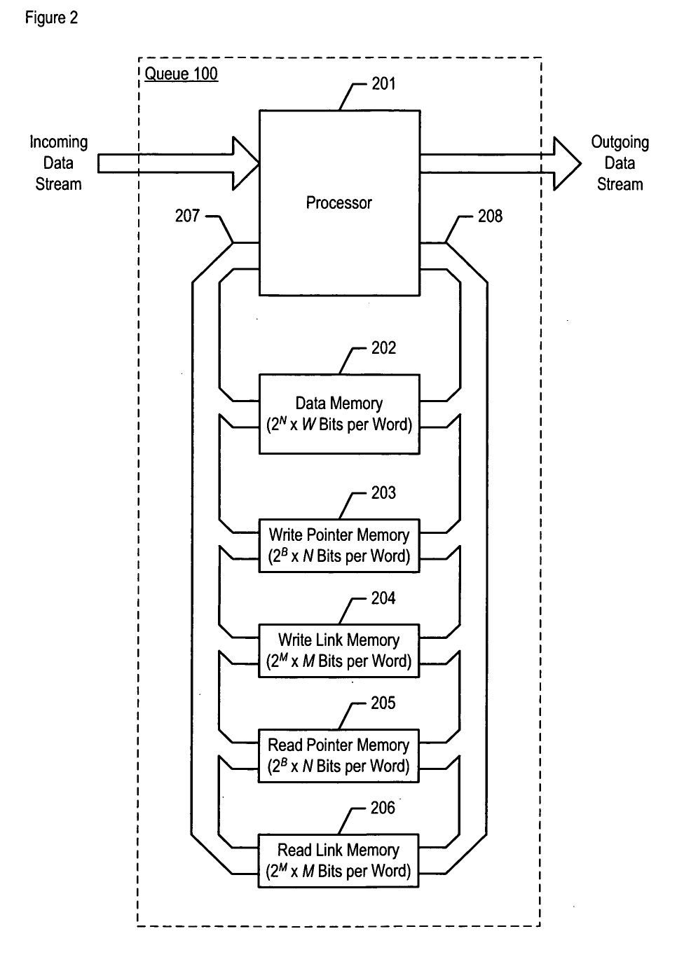

FIG. 2 depicts a block diagram of the salient components of the illustrative embodiment of the present invention. Queue 101 comprises processor 201, data memory 202, write pointer memory 203, write link memory 204, read pointer memory 205, read link memory 206, address bus 207, and data bus 208, interconnected as shown.

Processor 201 is an appropriately-programmed general-purpose processor that is capable of performing the functionality described below and with respect to the accompanying figures. In particular, processor 201 is capable of:
i. receiving the stream of words from incoming data stream 102,
ii. demultiplexing incoming data stream 102 into its constituent channels,
iii. queueing each word within each channel for as long as appropriate,
iv. multiplexing the constituent channels into outgoing data stream 103, while preserving the integrity of the sequence of words within each channel, and
v. transmitting the multiplexed stream on outgoing data stream 103.
   Furthermore, processor 201 is capable of:
vi. increasing and decreasing the number of channels during operation hitlessly, and
vii. increasing and decreasing the capacity of each channel's queue during operation hitlessly.

Data memory 202 is a random-access read & write memory that comprises 2^{N} individually-addressable W-bit words, wherein N is a positive integer. Data memory 202 is where processor 201 stores the words received from incoming data stream 102 while they are awaiting transmission on outgoing data stream 103. In accordance with the illustrative embodiment, N=14, but it will be clear to those skilled in the art, after reading this disclosure, how to make and use alternative embodiments of the present invention for any value of N.

Data memory 202 is logically partitioned into 2^{M} blocks of 2^{P} words, wherein M is a positive integer and N≧M, and wherein P is a non-negative integer equal to N−M. The purpose of partitioning data memory 202 into blocks is to reduce the size of write link memory 204 and read link memory 206, which would be larger if data memory 202 were not partitioned into blocks.

Write pointer memory 203 is a random-access read & write memory that comprises 2^{H} individually-addressable N-bit words, wherein H is a positive integer and j≦2^{H}. Location c, wherein c ε {0, . . . j−1}, stores a pointer that points to the location in data memory 202 where the next word for channel c is to be stored. In accordance with the illustrative embodiment, H=7, but it will be clear to those skilled in the art, after reading this disclosure, how to make and use alternative embodiments of the present invention for any value of H.

In accordance with the illustrative embodiment, each N-bit word in write pointer memory 203 is a composite of a M-bit word and a P-bit word as depicted in Table 1.

TABLE 1
Format of N-Bit Word As Composite of M-Bit Word and P-Bit Word

| | | | | | | | | | | | | | |
|---|---|---|---|---|---|---|---|---|---|---|---|---|---|
| N₁₃ | N₁₂ | N₁₁ | N₁₀ | N₉ | N₈ | N₇ | N₆ | N₅ | N₄ | N₃ | N₂ | N₁ | N₀ |
| M₉ | M₈ | M₇ | M₆ | M₅ | M₄ | M₃ | M₂ | M₁ | M₀ | P₃ | P₂ | P₁ | P₀ |

Write link memory 204 is a random-access read & write memory that comprises 2^{M} individually-addressable M-bit words. Each word in write-link memory 204 is a pointer in a linked list that is uniquely associated with one channel. When the number of channels and the depth of a queue is stable, its linked list is a circular linked-list. When the number of channels or the depth of the queue is unstable—its linked list is temporarily not a circular linked list. In particular, location m, wherein m ε {0, . . . 2^{M}−1}, stores a pointer in a linked list that (1) points to the next link in the list, and (2) the next block in data memory 201 for writing words associated with that channel.

Read pointer memory 205 is a random-access read & write memory that comprises 2^{H} individually-addressable N-bit words. Location c stores a pointer that points to the location in data memory 202 where the next word for channel c is to be read from. In accordance with the illustrative embodiment, each N-bit word in read pointer memory 205 is a composite of a M-bit word and a P-bit word as depicted in Table 1.

Read link memory 206 is a random-access read & write memory that comprises 2^{M} individually-addressable M-bit words. Each word in read-link memory 206 is a pointer in a linked list that is uniquely associated with one channel. When the number of channels and the depth of a queue is stable, its linked list is a circular linked-list. When the number of channels or the depth of the queue is unstable—its linked list is temporarily not a circular linked list. The topology of the linked lists in read link memory 206 always follow the topology of the linked lists in write link memory 204, which is partially what enables the illustrative embodiment to be resizable without losing data. In particular, location m, wherein m ε {0, . . . 2^{M}−1}, stores a pointer in a linked list that (1) points to the next link in the list, and (2) the next block in data memory 201 for reading words associated with that channel.

FIG. 3 depicts a flowchart of the salient tasks associated with the operation of the illustrative embodiment.

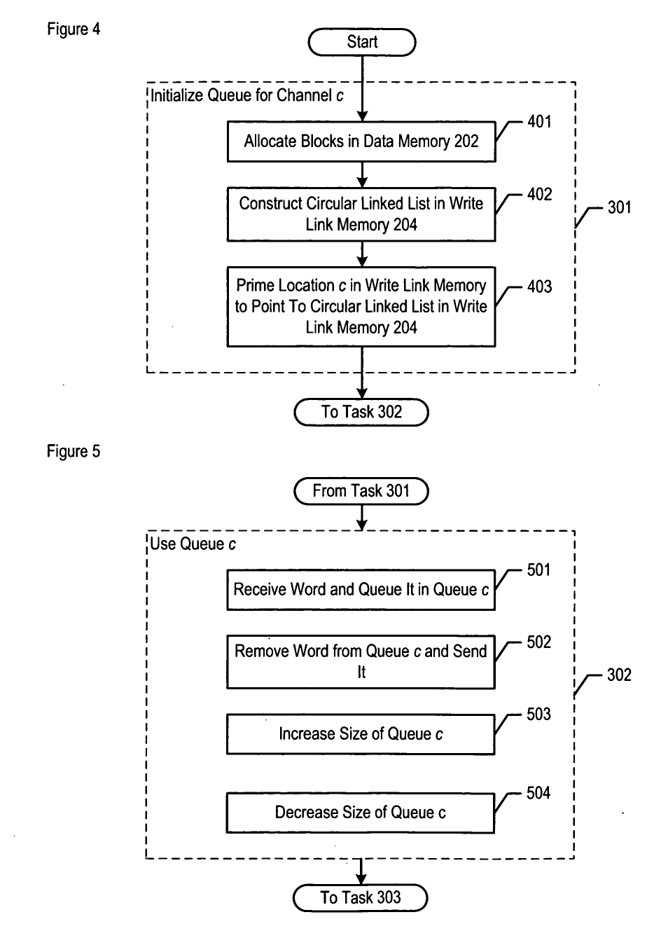

At task 301, the illustrative embodiment learns that it must provide a queue for channel c, and processor 201 allocates one or more blocks in data memory 202 for that queue. In accordance with the illustrative embodiment, processor 201 is told how many blocks in data memory 202 to (at least initially) allocate to queue c. It will be clear to those skilled in the art, after reading this disclosure, how to make and use alternative embodiments of the present invention in which processor 201 automatically and dynamically allocates blocks in data memory 202 to the respective buffers based on, for example, the frequency and severity of overflow and underflow events. Task 301 is described in detail below and with respect to FIG. 4.

At task 302, the illustrative embodiment uses queue c. In accordance with the illustrative embodiment, processor 201 uses queue c. Task 302 is described in detail below and with respect to FIG. 5.

At task 303, the illustrative embodiment learns that it no longer needs to provide a queue for channel c, and processor 201 de-allocates the blocks associated with that queue in data memory 202 for use by other channels. Task 303 is described in detail below and with respect to FIG. 6.

FIG. 4 depicts a flowchart of the salient tasks associated with the performance of task 301.

At task 401, processor 201 begins the process of creating queue c with B_{c} blocks of memory, wherein B_{c} is a positive integer, by allocating B_{c} blocks in data memory 202 that are not being used. Processor 201 accomplishes this by consulting a data structure of used blocks as illustrated in Table 2.

TABLE 2
Data Structure of Blocks Used in Data Memory 202

| Name | Used or Unused |
|---|---|
| 0x000 | Used |
| 0x001 | Used |
| . . . | . . . |
| 0x007 | Unused |
| . . . | . . . |
| 0x042 | Unused |
| . . . | . . . |
| 0x134 | Unused |
| . . . | . . . |
| 0x354 | Unused |
| . . . | . . . |
| 0x3FE | Used |
| 0x3FF | Used |

The blocks can be, but need not be, contiguous in data memory 202. In accordance with the illustrative embodiment, the data structure of used blocks is stored in processor 201's scratch pad memory, but it will be clear to those skilled in the art how to store it in other formats and in other places, such as an extra bit on write link memory 204. When processor 201 has located B_{c} unused blocks, it marks them as used in the data structure of used blocks.

At task 402, processor 201 constructs a circular linked list using the B_{c} blocks allocated in task 401 in write link memory 204. For example, suppose that blocks 0×007, 0×042, 0×134 were allocated for a new queue for channel c=0×2F in task 402. As part of task 402, processor 201 could construct the circular linked list in write link memory 204 by writing 0×042 in memory location 0×007, 0×134 in memory location 0×042, and 0×007 in memory location 0×134, as depicted in Table 3 and FIG. 11. As FIG. 11 depicts, each pointer in write link memory 204 (1) points to the next link in the list, and (2) the next block in data memory 201 for writing words associated with that channel.

TABLE 3
Write Link Memory 204

| | |
|---|---|
| 0x000 | — |
| 0x001 | — |
| . . . | . . . |
| 0x007 | 0x042 |
| . . . | . . . |
| 0x042 | 0x134 |
| . . . | . . . |
| 0x134 | 0x007 |
| . . . | . . . |
| 0x3FE | — |
| 0x3FF | — |

In accordance with the illustrative embodiment, the linked list is not written into read link memory 206 at this time, but it will be clear to those skilled in the art, after reading this disclosure, that it can be written into read link memory 206 at this time or at another time before it is used.

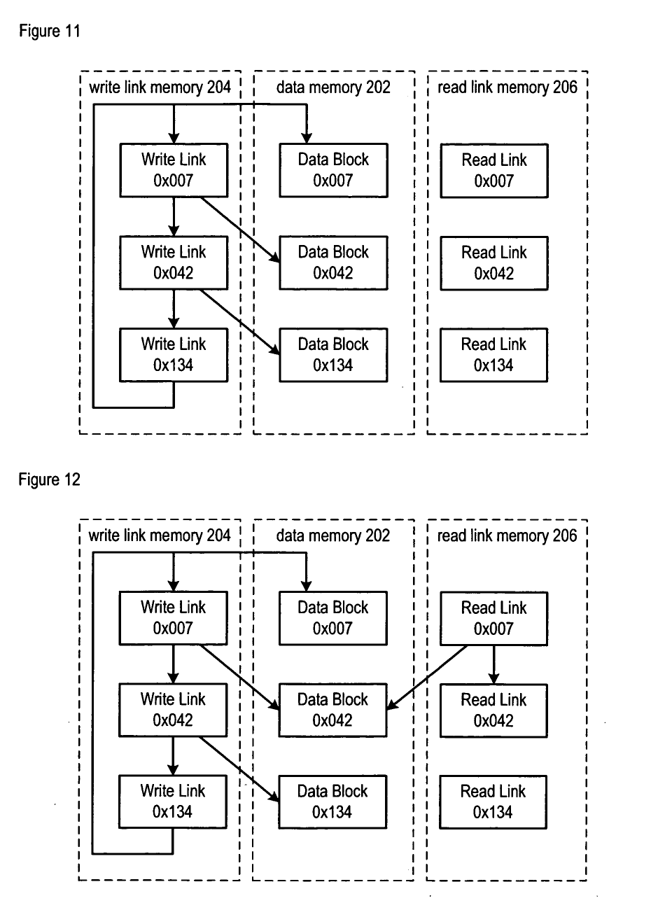

At task 403, processor 201 primes location c in write pointer memory 203, as depicted in Table 4, and location c in read pointer memory 203, as depicted in Table 5, with an N-bit word that is a composite of the address of a link in the circular link list constructed in task 402 and a P-bit word equal to 0×0, as depicted in Table 1. The illustrative linked list is also depicted in FIG. 12.

TABLE 4
Write Pointer Memory 203 (Primed for c = 0x2F)

| | |
|---|---|
| 0x00 | — |
| 0x01 | — |
| . . . | . . . |
| 0x2F | 0x0070 |
| . . . | . . . |
| 0x7E | — |
| 0x7F | — |

TABLE 5
Read Pointer Memory 205 (Primed for c = 0x2F)

| | |
|---|---|
| 0x00 | — |
| 0x01 | — |
| . . . | . . . |
| 0x2F | 0x0070 |
| . . . | . . . |
| 0x7E | — |
| 0x7F | — |

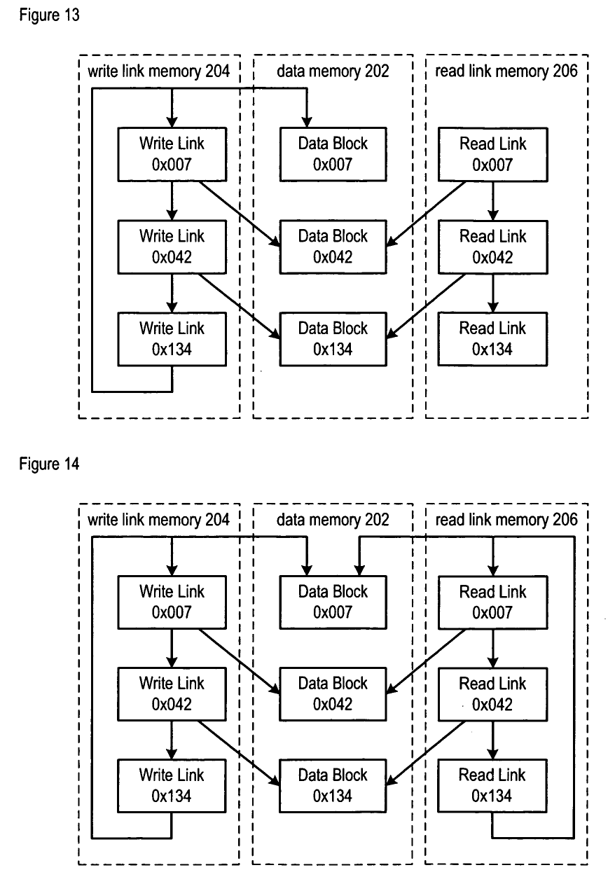

After the completion of task 403, queue c is ready for operation. The linked list in read link memory 206 will be constructed, link by link, as described in detail below, as processor 201 progressively fills the data blocks in data memory 202. For example, when processor 201 has completed filling data block 0×042, processor 201 will write 0×134 into read link 0×042, as depicted in FIG. 13. When processor fills data block 0×134, processor 201 will write 0×007 into read link 0×134, as depicted in FIG. 14, to complete the circular linked list.

The doubly-links data structure, with separate read and write link structures depicted in FIG. 14, remains in effect until the queue is either increased or decreased in size or deallocated.

FIG. 5 depicts a flowchart of the salient tasks associated with the performance of task 302. Task 302 comprises four distinct tasks that can be performed in any order, in any combination, and as many times as are appropriate for incoming data stream 102 and the construction of outgoing data stream 103. It will be clear to those skilled in the art, after reading this disclosure, how to make and use embodiments of the present invention that perform task 302.

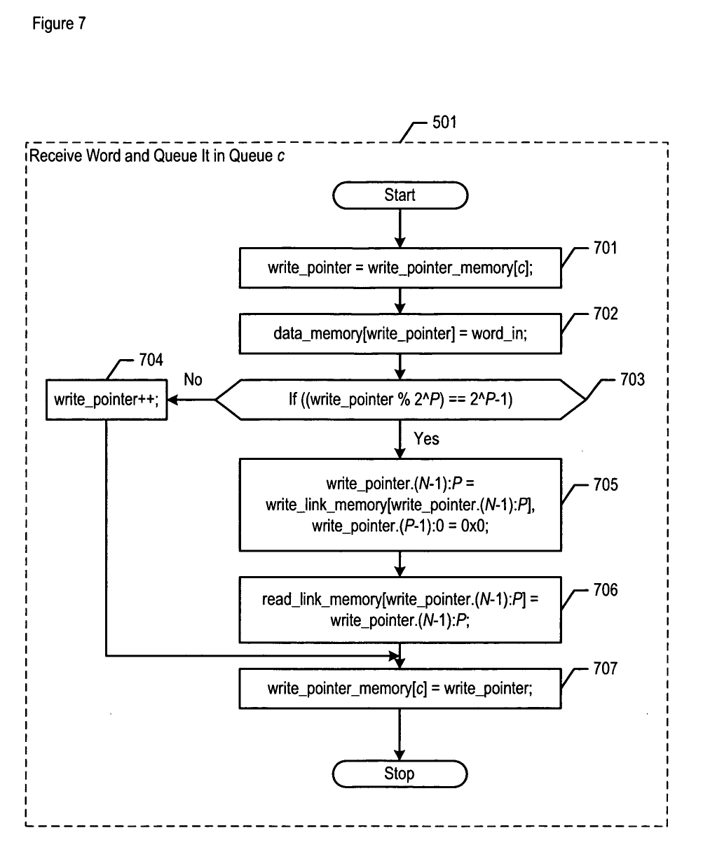

At task 501, processor 201 receives a W-bit word, called word_in, from incoming data stream 102, determines that it is within channel c, and stores it in queue c. Task 501 is described in detail below and with respect to FIG. 7.

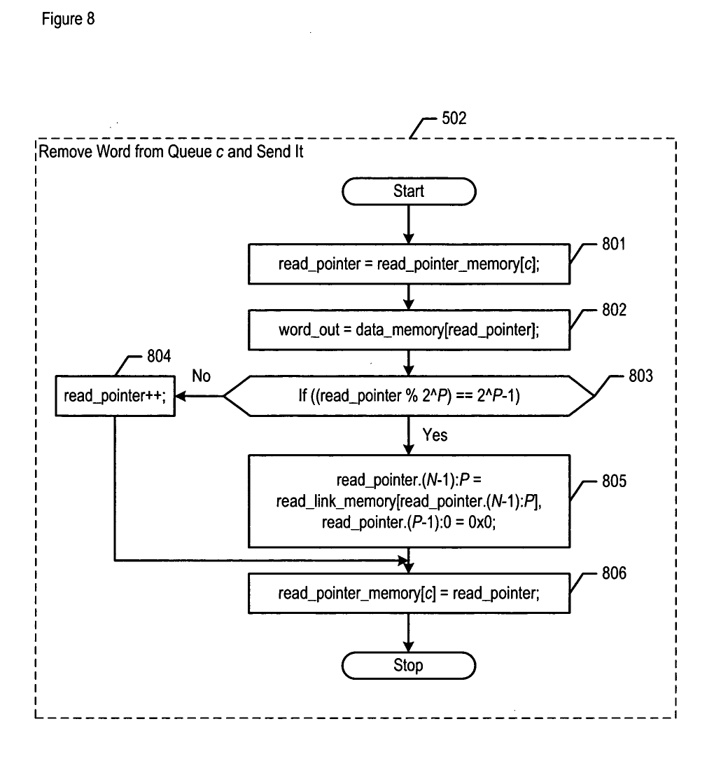

At task 502, processor 201 removes a word from queue c and transmits it in channel c in outgoing data stream 103. Task 502 is described in detail below and with respect to FIG. 8.

At task 503, processor 201 increases the size (i.e., depth) of queue c by adding a data block in data memory 202 to the queue. When multiple data blocks are to be added to the queue, task 503 is performed once for each block. It will be clear to those skilled in the art, however, after reading this disclosure, how to make and use embodiments of the present invention in which the size of a queue is increased by any number of data blocks at a time.

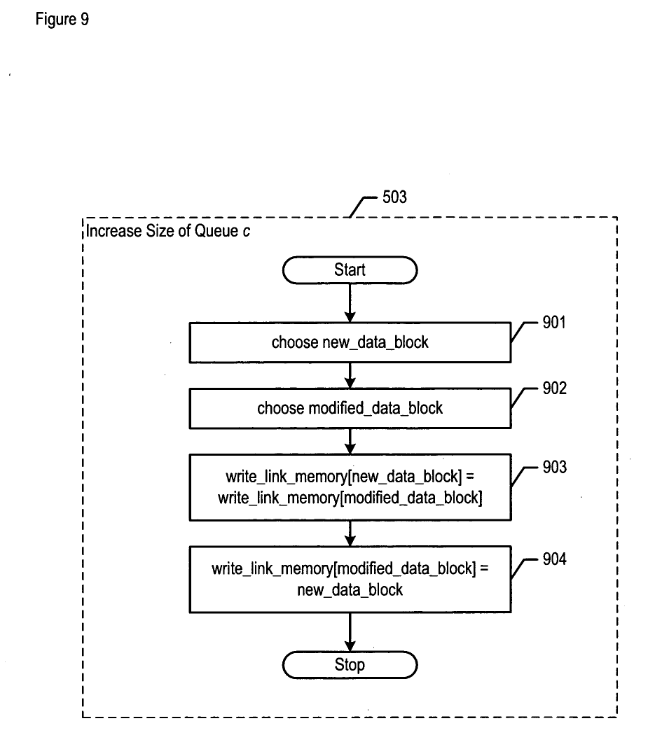

Task 503 is performed when:
i. s_{c} increases, or
ii. d_{c} needs to be increased, or
iii. both i and ii.
   Task 503 is described in detail below and with respect to FIG. 9.

At task 504, processor decreases the size of queue c by deleting a data block in data memory 202 from the queue. When multiple data blocks are to be deleted from the queue, task 504 is performed once for each block. It will be clear to those skilled in the art, however, after reading this disclosure, how to make and use embodiments of the present invention in which the size of a queue is decreased by any number of data blocks at a time.

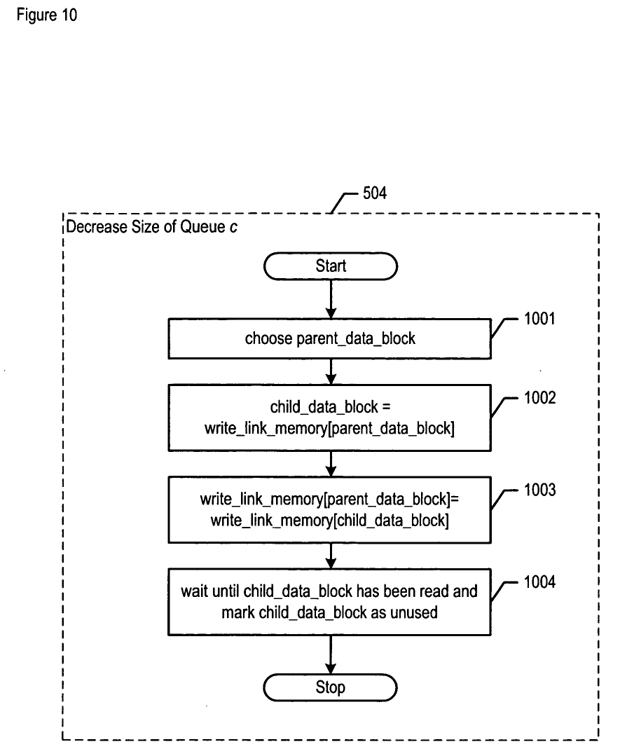

Task 504 is performed when:
i. s_{c} decreases, or
ii. d_{c} needs to be decreased, or
iii. both i and ii.
   Task 504 is described in detail below and with respect to FIG. 10.

FIG. 6 depicts a flowchart of the salient tasks associated with the performance of task 303.

At task 601, processor 201 marks the data blocks currently used in queue c as available for use in the data structure of used blocks as illustrated in Table 2. In accordance with the illustrative embodiment, nothing else needs to be done to de-allocate queue c. The values associated with queue c in data memory 202, write-pointer memory 203, write-link memory 204, read-pointer memory 205, and read-link memory 206 will be ignored by processor 201 until they are needed again and then they will be overwritten.

FIG. 7 depicts a flowchart of the salient tasks associated with the performance of task 501, in which processor 201 receives a word from incoming data stream 102, determines that it is within channel c, and stores it in queue c.

At task 701, processor 201 retrieves the pointer into data memory 202 for word_in. This is accomplished by setting an N-bit variable, write_pointer, equal to the contents of location c in write pointer memory 203.

At task 702, processor 201 writes the word to be buffered into data memory 202 at the location pointed to by the variable write_pointer.

At task 703, processor 201 tests if the variable write_pointer is at the boundary of a data block. This can be determined for example, by checking if the P least significant bits of the variable write_pointer are “1”. If it is, then control passes to task 705; otherwise control passes to task 704.

At task 704, processor 201 increments write_pointer by one so that write_pointer points to the next location in the current data block in data memory 202.

At task 705, processor 201 prepares to update the write pointer to be based on the next link in the linked list stored in write link memory 204. This is accomplished by setting the most significant N-P bits of write_pointer equal to the contents of write link memory 204 at the location pointed to by the most significant N-P bits of write_pointer, and by setting the least significant P bits of write_pointer equal to 0×0.

At task 706, processor 201 updates the linked list for queue c in read link memory 206 to ensure that it is consistent and synchronized with the linked list for queue c in write link memory 204. This is accomplished by setting the contents of read link memory 206 at the location pointed to by the most significant N-P bits of write_pointer equal to the most significant N-P bits of write_pointer.

At task 707, processor 201 writes the variable write_pointer back into write pointer memory 203 so that it can be used for the next word to be buffered for channel c. To accomplish this, processor 201 sets the contents of write pointer memory 203 at the location pointed to by c equal to the variable write_pointer.

FIG. 8 depicts a flowchart of the salient tasks associated with the performance of task 502, in which processor 201 removes a word from queue c, word_out, and transmits it in channel c of outgoing data stream 203.

At task 801, processor 201 retrieves the pointer into data memory 202 where word_out is stored. This is accomplished by setting an N-bit variable, read_pointer, equal to the contents of location c in read pointer memory 205.

At task 802, processor 201 reads word_out from data memory 202 using the variable read_pointer. This is accomplished by setting word_out to the contents of data memory 202 at the location pointed to by the variable read_pointer.

At task 803, processor 201 tests if the read_pointer is at the boundary of a data block. This can be determined for example, by checking if the P least significant bits of the variable read_pointer are “1”. If it is, then control passes to task 805; otherwise control passes to task 804.

At task 804, processor 201 increments read_pointer by one so that read_pointer points to the next location in the current data block in data memory 202.

At task 805, processor 201 prepares the new read pointer, which is based on the next link in the linked list stored in read link memory 206. This is accomplished by setting the most significant N-P bits of read_pointer equal to the contents of read link memory 206 at the location pointed to by the most significant N-P bits of read_pointer, and by setting the least significant P bits of read_pointer equal to 0×0.

At task 806, processor 201 writes the variable read_pointer back into read pointer memory 205 so that it can be used for the next word for be removed from queue c. To accomplish this, processor 201 sets the contents of read pointer memory 205 at the location pointed to by c equal to the variable read_pointer.

FIG. 9 depicts a flowchart of the salient tasks associated with the performance of task 503. Continuing with the example above, FIG. 14 depicts queue c at the beginning of task 503.

At task 901, processor 201 chooses the new data block in data memory 202 to insert into queue c by consulting the data structure of used blocks, as depicted in Table 2. Any currently unused data block will suffice, and the name of that data block is represented by the M-bit variable new_data_block. When the data block is chosen, it is marked as used in the data structure of used blocks. In accordance with the example, the new data block has address 0×354 (i.e., new_data_block=0×354).

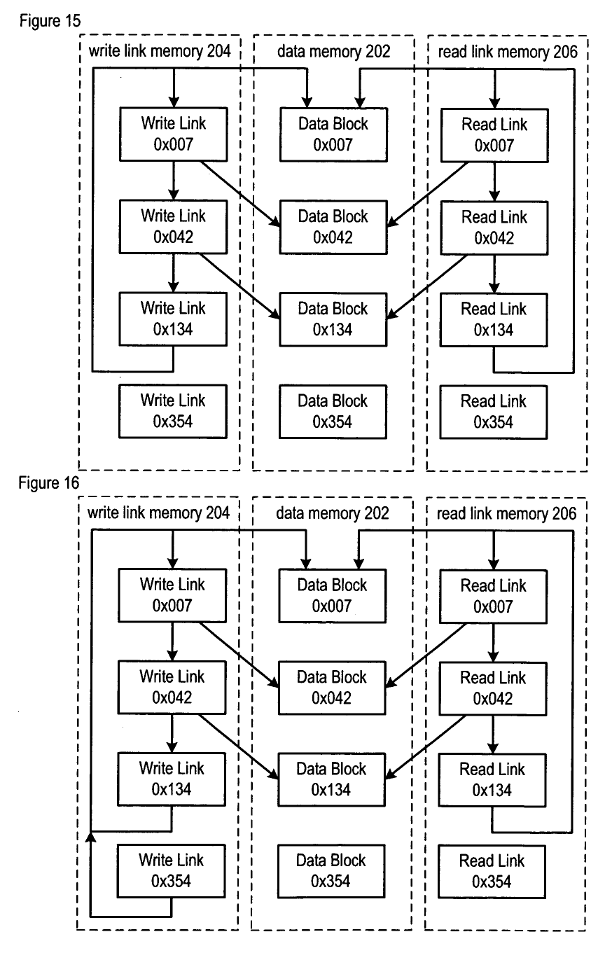

At task 902, processor 201 chooses a data block in queue c to insert the new_data_block after. Any data block in queue c will suffice, and the name of that data block is represented by the M-bit variable modified_data_block. In accordance with the example, the data block to insert the new block after is 0×134 (i.e., modified_data_block=0×134) as shown in FIG. 15.

At task 903, processor 201 sets the contents of the location pointed to by new_data_block in write link memory 204 to the contents of the location pointed to by modified_data_block in write link memory 204. This is the first task in inserting the new data block into queue c. In accordance with the example, FIG. 16 depicts queue c after task 903 has been performed.

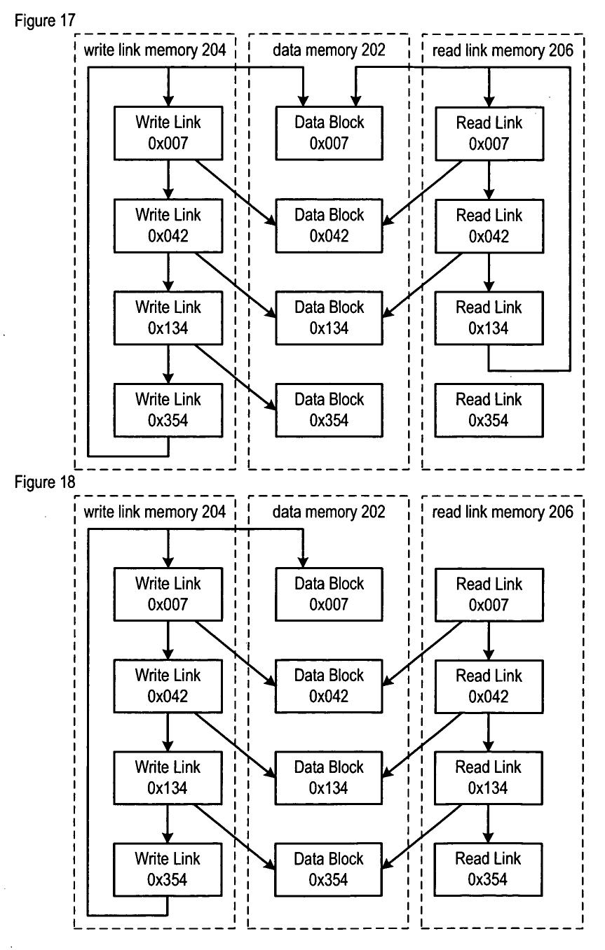

At task 904, processor 201 performs the second task in inserting the new data block into queue c. To accomplish task 904, processor 201 sets the contents of the location pointed to by modified_data_block in write link memory 204 equal to new_data_block. In accordance with the example, FIG. 17 depicts queue c after task 904 has been performed.

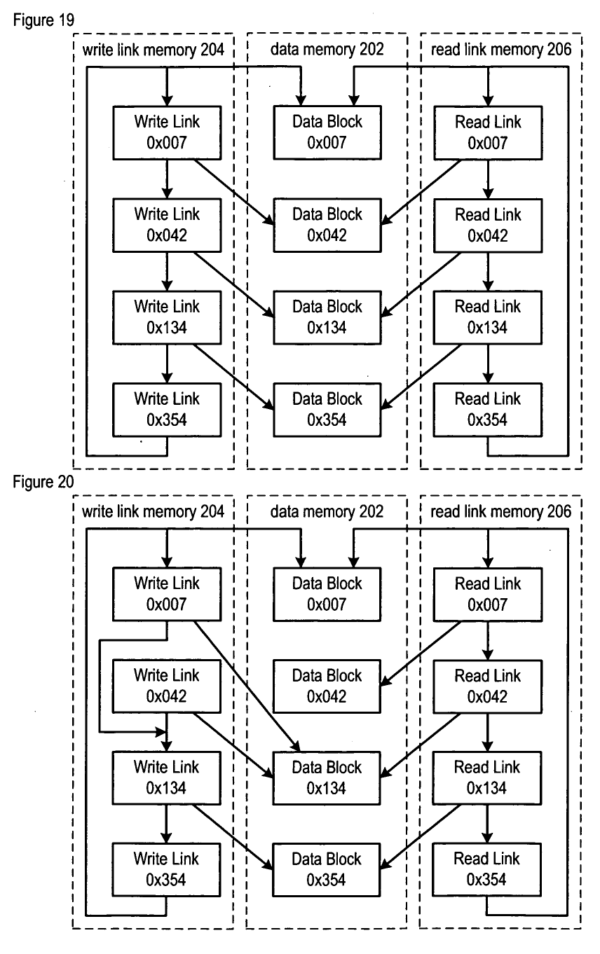

Read link memory 206 is not modified within task 503 to reflect the addition of the new data block, but is updated in task 805 when it occurs. In other words, when data block 0×134 is next filled, processor 201 will copy the contents of location 0×134 in write link memory 204 (i.e., 0×354) into location 0×134 in read link memory 206. In accordance with the example, FIG. 18 depicts queue c after this task. When data block 0×354 is next filled, processor 201 will copy the contents of location 0×354 in write link memory 204 (i.e., 0×007) into location 0×354 in read link memory 206. In accordance with the example, FIG. 19 depicts queue c after this task.

FIG. 10 depicts a flowchart of the salient tasks associated with the performance of task 504.

At task 1001, processor 201 chooses a data block in queue c. Any data block will suffice, and the name of that data block is represented by the M-bit variable parent_data_block. In accordance with the example, parent_data_block equals 0×007.

At task 1002, processor 201 determines the name of the data block that follows parent_data_block in queue c by using parent_data_block as an index into write link memory 204. The name of the data block that follows parent_data_block in queue c is represented by the M-bit variable child_data_block. It is the data block pointed to by the variable child_data_block that will be removed from queue c. In accordance with the example, child_data_block equals 0×042.

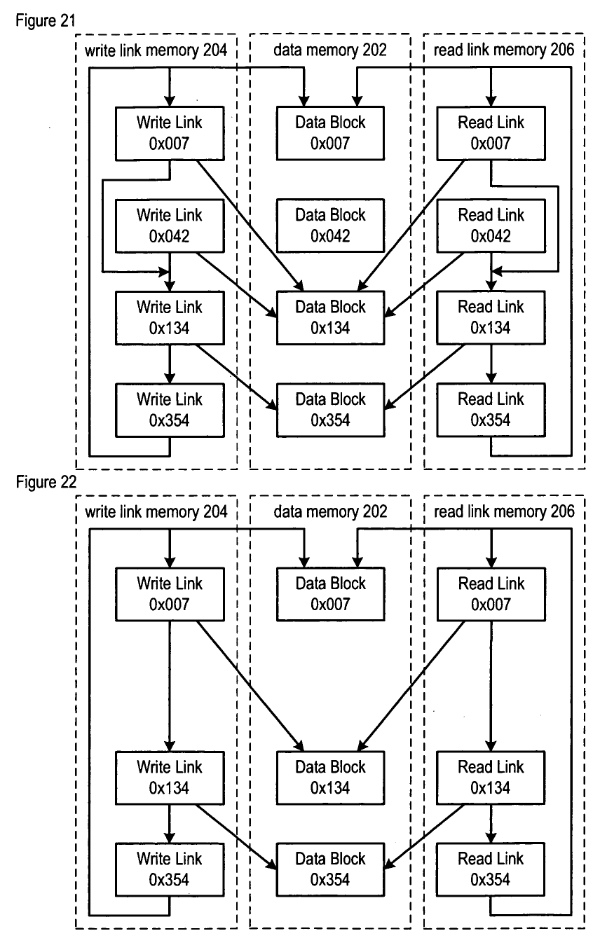

At task 1003, processor 201 performs the first task in removing the child data block from queue c by setting the contents of parent_data_block in write link memory 204 equal to the contents of child_data_block in write link memory 204. FIG. 20 depicts queue c after the completion of task 1003. Read link memory 206 is not modified within task 504 to reflect the removal of the child_data_block, but is updated in task 805 when it occurs. FIG. 21 depicts queue c after the completion of task 504 to reflect the removal of the child_data_block.

At task 1004, processor 201 waits until the data block in data memory 202 pointed to by child_data_block has been read (for the last time as part of queue c), and then marks child_data_block in the data structure of used data blocks as available for use. In the worst case, processor 201 must wait for Y+1 words to be read from queue c before re-using child_data_block, wherein Y is a positive integer that represents the length of queue c in words before task 306 is initiated. FIG. 22 depicts queue c after the completion of task 1004.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A system comprising:
a first memory comprising 2^{N} individually-addressable words;
a second memory comprising 2^{M} individually-addressable M-bit words, wherein each of said M-bit words is (1) a pointer into said second memory and (2) at least a portion of a pointer into said first memory; and
a third memory comprising 2^{M} individually-addressable M-bit words, wherein each of said M-bit words is (1) a pointer into said third memory and (2) at least a portion of a pointer into said first memory;
wherein M and N are positive integers and N≧M.

2. The system of claim 1 wherein second memory comprises a plurality of linked-lists and said third memory comprises a plurality of linked-lists.

3. The system of claim 1 further comprising:
a write-pointer memory comprising B individually-addressable N-bit words, wherein each of said N-bit words is a pointer into said first memory, and wherein M bits of each of said N-bit words is a pointer into said second memory; and
a read-pointer memory comprising B individually-addressable N-bit words, wherein each of said N-bit words is a pointer into said first memory, and wherein M bits of each of said N-bit words is a pointer into said third memory;
wherein B is a positive integer.

4. A method comprising:
reading an M-bit pointer from a first memory that comprises 2^{M} individually-addressable M-bit words;
writing a word to a second memory using said M-bit pointer as a portion of said address;
writing said M-bit pointer to a third memory that comprises 2^{M} individually-addressable M-bit words;
reading said M-bit pointer from said third memory; and
reading said word from said second memory using said M-bit pointer as a portion of said address.

5. The method of claim 4 wherein said M-bit pointer is a link in a linked list.

6. A method comprising:
reading a first N-bit pointer from a first memory that comprises B individually-addressable N-bit words using B as the address;
writing a word to a second memory that comprises 2^{N} individually-addressable words using said first N-pointer as the address;
reading a first M-bit pointer from a third memory that comprises 2^{M} individually-addressable M-bit words using said at least a portion of said first N-bit pointer as the address; and
writing said first M-bit pointer into said first memory using B as the address.

7. The method of claim 6 wherein said M-bit pointer is a link in a linked list.

8. The method of claim 6 further comprising:
reading a second N-bit pointer from a fourth memory that comprises B individually-addressable N-bit words using B as the address;
writing said word from said second memory using said second N-bit pointer as the address;
reading a second M-bit pointer from a fifth memory that comprises 2^{M} individually-addressable M-bit words using said at least a portion of said second N-bit pointer as the address; and
writing said first M-bit pointer into said fifth memory using B as the address.
